(19) United States
(12) Patent Application Publication
(10) Pub. No.: US 2008/0208800 A1
(43) Pub. Date: Aug. 28, 2008

(54) Method and System For Increasing Invention

(75) Inventors: Gary Markovits, Lavallette, NJ (US); Devin Carl Markovits, Esopus, NY (US)

Correspondence Address: Carlos R. Villamar;Nixon Peabody, 401 9th Street N. W., Suite 900, Washington, DC, 20004-2128, US

(73) Assignee: Innovation Business Partners, Inc., Lavallette, NJ (US)

(21) Appl. No.: 11/631,847

(22) PCT Filed: Jul. 13, 2005
(86) PCT No.: PCT/US05/24659

§ 371 Date: Jan. 29, 2008

Related U.S. Application Data
(60) Provisional application No. 60/587,868, filed on Jul. 15, 2004.

(51) Int. Cl. G06F 7/06

(52) U.S. Cl. 707/3; 707/E17.014

(57) ABSTRACT

A computer assisted, convergent iterative method and system for creating an optimal definition of a problem or need, the optimal definition including a critical challenge (CC), and producing a solution thereto, including providing an initial statement of the problem or need, and iteratively performing a computer assisted search method until either ideal solution characteristics of the CC have been satisfied and the CC is considered solved or the definition of the CC is configured in a maximally optimal form. A computer assisted method and system of finding innovative and creative solutions to a problem or need also are provided, including providing an initial problem or need statement expressed in an optimal form, providing a database of related problems and solutions thereto, and analyzing attributes of the solutions to determine a method or means to create a solution to the initial problem or need.

### FIELD OF THE INVENTION

This invention relates to a computer assisted system and method for increasing the rate of invention of a client group such as a group of engineers or scientists. In particular, this invention relates to a computer assisted system and method, wherein information is extracted from documented inventions, creative acts, and products of others, and the extracted information is processed and transformed into a form that is used within a novel brainstorming technique to enhance the creativity, problem solving ability and inventiveness of the client group.

### DESCRIPTION OF THE RELATED ART

In the past, competitive advantage was closely related to control or ownership of physical assets such as land, basic materials and human capital. Methods and systems to derive the greatest value from those physical assets were key tools in establishing and maintaining that competitive advantage. As a result, corporations invested large sums of money on systems to control inventory, manufacturing, finance and human resources.

Today competitiveness is a function of innovation, which the President's Council on Competitiveness defines as the ability to deliver to the market a continuous stream of commercially relevant products and services. Stated another way, competitive advantage, as well as economic growth generally, now results from the increasing returns associated with intellectual property rather than real property.

As an example, if one takes the same amount of silicon, copper, aluminum, plastic, etc., that was contained in the original 1982 vintage IBM XT personal computer and assembles a computer using the same physical assets but applying today's methods, you will produce a computer that has one hundred to one thousand times the computing power of the original XT. The additional value (improved functionality) is, therefore, not derived from the physical assets themselves, but from the new knowledge of how to assemble a computing device using those assets.

Conversely, one can provide improved functionality by combining new assets or elements in a relationship substantially similar to that, which produced a previous invention. For example, power transistors can be produced by replacing silicon with gallium arsenide in substantially the same relationship of base, emitter and gate familiar to the common silicon transistor. Finally, new assets or elements can be combined in entirely new relationships and can conceivably produce a product with functionality totally different from anything obtained previously.

The inventive process, which depends so intimately on available assets and methods of using them, is closely associated with creativity. A creative act, in response to a challenge or task, is widely understood to be an act that is novel, appropriate and valuable when applied to that challenge or task.

Creativity, as we shall use the term herein, has three components. In order to be creative when confronting a task in a given field (e.g., hereinafter referred to as the domain) an individual employs:

(1) Domain relevant skills,

(2) Creativity relevant skills,

(3) Task motivation.

The first component expresses the fact that it is unlikely someone without knowledge of nuclear physics (considered only as an exemplary domain) will invent in the field of nuclear physics. The second component states that a familiarization with, or facility for creativity skills (e.g. problem solving skills, novel modes of thought, forming new ideas etc.) is also important.

While the first two components refer to specific skills, the third component is directed at desire or motivation. An engineer can be an expert in his/her domain of activity, be familiar with brainstorming and be able to apply ideation and other creativity relevant skills, but without proper motivation to address the task or challenge at hand those abilities will not be applied.

Attempts have been made to place the creative process on a systematic level so that an inventor can, in effect, grow an invention in a series of cumulative and repetitive process steps. Cronin (U.S. Patent Application Publication No. US 2001/0049670 A1) discloses such a systematic, almost algorithmic approach wherein a basic invention is grown in a series of six steps including: 1) identifying the invention; 2) selecting a questioning theme; 3) identifying an aspect of the invention that falls within the theme; 4) identifying enhancements to the invention by one or more of its inventors; 5) repeating the third and fourth steps to sharpen the invention and 6) repeating the second through 5th steps for additional themes.

The relationship between creative acts and patentable invention has also been noted. In this regard, Cronin (U.S. Patent Application Publication No. US 2001/0047269) also discloses a systematic method for identifying patentable aspects of inventions.

Although Cronin, cited above, addresses the process of identifying patentable aspects of what has been invented, there is no aspect of this process that suggests a method of inventing or that with proper tools and understanding a database of prior art patents can be used as a knowledge base of creativity.

The use of the computer as an aid or adjunct to systematizing the inventive process has also been documented. In this regard, Cronin (U.S. Patent Application Publication No. US 2001/0049670 A1) also teaches a systematic method for facilitating the conception of an invention that incorporates the digital computer as an adjunct to systematizing creativity. In this approach, the computer essentially accepts and stores a variety of statement types regarding the invention that are put forth by its inventors. An example of such statements are those that Cronin entitles “WIBNI” or “wouldn't it be nice if” statements. In short, the computer plays the role of a gadfly or external stimulus to push the creative process forward.

A shortcoming of all the previous approaches and others like them to be found in the prior art, is that they neither fully and systematically address, enhance and incorporate the domain relevant skills of the inventors, nor do they directly address task motivation.

Creativity enhancing tools such as brainstorming depend for their success upon the collective knowledge of those that are using the tools. The effective size for a brainstorming group is limited, however, and while the tools such as those documented above may help participants to think of new relationships (“R”) between elements (“E”) which may be useful in constructing an invention, the total number of elements and relationships the participants bring to the session is limited by size of the group and their previous experiences.

Some creativity techniques try to solve this problem by randomly introducing new elements. For example, a lateral thinking technique called provocation instructs participants to randomly select a word from a book or dictionary and then brainstorm how this random element might contribute to a unique solution. Still other techniques, such as visually induced relationships, suggest taking a random image and identifying its attributes such as brightness, color, contrast, size relationships, etc., and then applying those attributes to the problem or solution the group is brainstorming. Again, the success of such techniques is limited by the size of the group and the past experiences of its participants.

### SUMMARY OF THE INVENTION

Therefore there is a need for a method or system to increase the number of relevant elements and relationships that a group can consider to solve a given problem. Where better to find such elements than in the accumulated inventive efforts stored within the patents of the USPTO and other patent offices. The use of existing patents to gain technological insights and to acquire prior art relevant to new patent applications is well known to inventors. The scope and impact of patents on technological developments in business and on consequent business success has been recognized and the use of patents as an indicator of business success has even been applied systematically to enhance performance within the financial markets. Breitzman (U.S. Pat. No. 6,175,824 B1) teaches a method of choosing a stock portfolio by evaluating the intellectual property holdings (e.g., patents) of a prospective list of publicly traded companies and purchasing the stocks of those companies whose patent holdings satisfy certain pre-selected criteria. It is noteworthy that these applied pre-selected criteria can be formulated mathematically as a summation of separate performance indicator, that are ascertainable and calculable from a patent database and can then be applied to the actual selection of stocks and the formation of a portfolio. The success of such an approach establishes that a database of patents is also a source of information and knowledge data that can be converted to a numerical form for processing and evaluating by a computer, so that subsequent actions can be implemented by a group of investors. It can, therefore, be inferred that such a database, when properly evaluated, processed and applied within the proper brainstorming method, will allow creative and inventive acts to be implemented by a group of inventors.

Accordingly, the exemplary embodiments provide a method and system for enhancing the creativity and inventiveness of a client group and to thereby enable them to produce the solution to a given problem, called herein the “critical challenge.” Advantageously, the exemplary embodiments provide an enhancement of task motivation, and appreciably increases domain relevant skills by “mining” (e.g., systematically extracting relevant knowledge from) a database of patents and publications, to form a knowledge base of analogous and non-analogous arts. The exemplary embodiments employ the results of database mining as an extrinsic motivator to facilitate an improved brainstorming process and, thereby, to enhance creativity skills. The exemplary embodiments provide an improved brainstorming process that, through a variety of perspectives and a succession of well designed steps, clearly, effectively and progressively sharpens and delineates the problem to be solved and permits a solution to be obtained.

Accordingly, in exemplary aspects of the present invention, a computer assisted, convergent iterative method and system for creating an optimal definition of a problem or need, the optimal definition including a critical challenge (CC), and producing a solution thereto are provided, including providing an initial statement of the problem or need, and iteratively performing a computer assisted search method until either ideal solution characteristics of the CC have been satisfied and the CC is considered solved or the definition of the CC is configured in a maximally optimal form.

In further exemplary aspects of the present invention, a computer assisted method and system of finding innovative and creative solutions to a problem or need also are provided, including providing an initial problem or need statement expressed in an optimal form, providing a database of related problems and solutions thereto, and analyzing attributes of the solutions to determine a method or means to create a solution to the initial problem or need.

Advantageously, the exemplary aspects provide a provision of tools for converting a database, for example, of patents, and the like, into a usable knowledge base for stimulating creativity and invention and the finer provision of the necessary understanding employed to appropriately use such a database.

Still other aspects, features, objects, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The objects, features and advantages of the present invention are understood within the context of the Detailed Description of the Preferred Embodiments, as set forth below. The Detailed Description of the Preferred Embodiments is understood within the context of the accompanying figures, wherein:

FIG. 1 is a diagram schematically indicating the challenge, solution and element/relationship spaces and subsets within those spaces and possible mappings between them.

FIG. 2 is a flow-chart illustrating a process to define the critical challenge.

FIG. 3 is a flow-chart illustrating the improved brainstorming process of the present invention used in conjunction with the database mining of the present invention.

### DETAILED DESCRIPTION OF THE PREFERRED EMBODIMENTS

The present invention includes recognition that a shortcoming of previous approaches and others like them to be found in the prior art, is that the previous approaches neglected to use the knowledge embodied in past inventions to expand domain relevant skills of inventors beyond what is already immediately known by the inventors. Such an expansion can be provided by the identification of separate and combined elements of prior art that may not fall precisely within the skill domains of the inventors. Although it is assumed that individual inventors are skilled or highly skilled in their arts, it is equally clear that there is a wealth of available and pertinent knowledge in their own art that is not known by them and it is even clearer that there is knowledge in analogous and even non-analogous arts that, if known, would be applicable to their inventive efforts. The present invention further includes the recognition that it is in the discovery of such knowledge that the application of computerized search procedures becomes invaluable.

A novel brainstorming method and system are provided, including application of a computer assisted method that “mines,” e.g., systematically extracts relevant knowledge from a database of patents and publications, and uses that extracted knowledge in a novel brainstorming process that, through a multiplicity of perspectives, progressively and systematically sharpens the definition of the problem and produces an approach to a solution.

Every year Organization for Economic Cooperation and Development (OECD) nations spend over half a trillion dollars on research and development. This exceeds by orders of magnitude the research and development budget of any single corporation, even that of the largest multi-national corporations. The results of the OECD research and development expenditures are documented in publications and patent databases worldwide. Advantageously, the exemplary embodiments systematically mine those databases and use the results to increase the rate of invention of scientists, engineers and people in general. Although the examination of patents and publications can be done without the use of a computer-based system, the increasing number of patents and publications and the amount of descriptive material presented within them renders such examination a daunting and almost hopelessly inefficient approach. In addition, it would be extremely difficult to adequately locate non-analogous art, precisely because it falls outside of the domains of the client group.

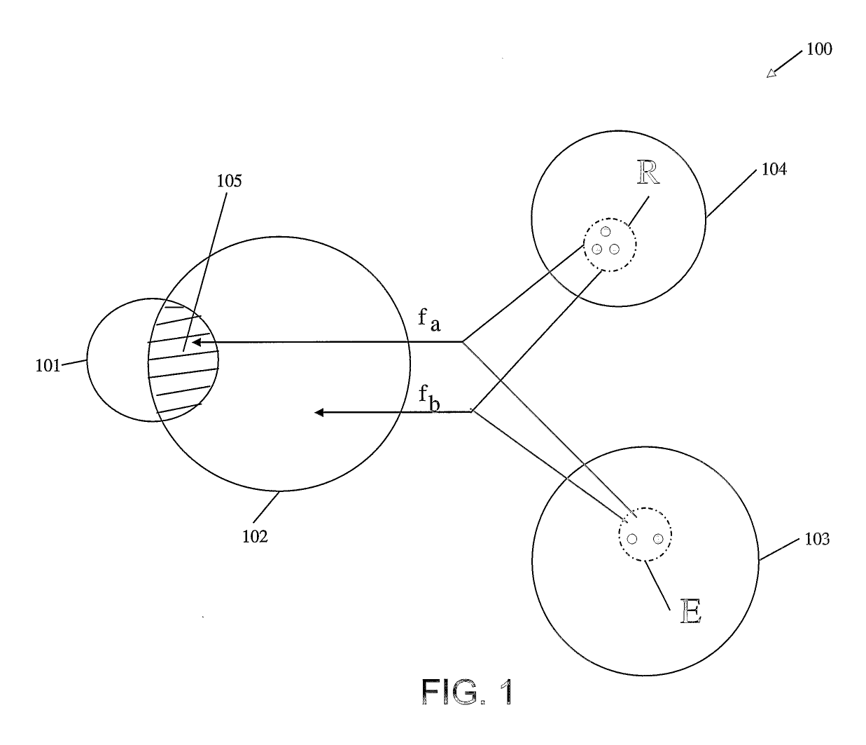

The exemplary embodiments systematically mine the database from multiple perspectives, the perspectives being “challenge-space” (e.g., the problem, or set of equivalent problems, to be solved), “solution-space” (e.g., a collection of possible solutions to the problem, not necessarily all equally satisfactory) and “element-relationship-space” (e.g., a set of elements and a set of relationships) which includes elements placed in the proper relationship with each other, so as to form a possible solution or part of such a solution. In terms of the following equation and what may be designated “an invention mapping” between spaces, which is schematically illustrated in FIG. 1, the method can be mathematically represented as follows:

I(C)=fₐ(E,R)

In the above equation an invention “I,” which responds to a need or challenge “C” can be represented as a functional solution “fₐ” which achieves the desired attributes “a” by combining the elements “E” in the unique relationship “R”.

Referring to the above equation and FIG. 1, the challenge-space corresponds to the left side of the equation “I(C)”, the problem or need to be addressed. Solution-space corresponds to “A” the new functionality with attributes “a” that solves the problem or meets the need. Element-relationship-space corresponds to the joint collection of elements “E” and relationships “R” that produce the new functionality.

Referring to FIG. 1, there are shown four approximately circular regions that represent the space of challenges 101, the space of potential solutions 102 to those challenges 101, a space of elements 103 which, properly related, can form a solution and a space of relationships between elements 104. A mapping, fₐ(E,R), takes elements, E, from 103 and relationships, R, from 104 and maps them into a solution with functionality (e.g., properties) “a.” If the created solution, which, by definition, is in space 102, has the desired properties then it intersects the space of challenges 101 (the subset 105 being the shaded intersection of 101 and 102), then an acceptable solution to the problem has been obtained. If a solution mapped by f_{b}, having functionality “b,” does not lie within the subset 105, then it does not constitute an acceptable solution. Note that the challenge space 101 is intentionally drawn so that it is not fully contained in the solution set, indicating that certain challenges may not be capable of solutions using existing elements and relationships. Under such circumstances, an enlargement of the R-space and/or the E-space may become necessary.

As a more concrete example of the method and terminology, imagine a client group is given the challenge of constructing a humane mousetrap that confines, but does not injure the mouse. The challenge space 101 is the space of all humane mousetraps. Solution space 102 might include all animal traps or, more broadly, all systems of confinement. The element space subset 103 might include all wire cages, sheet metal cages, bait, springs, nets, poisons, glues, etc, from which systems of confinement have been previously constructed. The relationship space subset 104 might include relationships such as placing bait within a wire cage, placing bait in front of a wire cage, forming a spring-loaded door on a wire cage, opening the door to the wire cage before baiting it, placing bait inside the cage and closing its door, etc. An acceptable mapping might select a wire cage and bait from element space, a relationship of placing the bait in front of an open door in the cage from relationship space and map that combination into a subset of solution space. If that subset of solution space is contained within the challenge space (e.g., if the solution so constructed is a humane mousetrap, thus, within the subset 105), then the challenge has been met. If, however, the solution does not posses the desired attributes of a humane mousetrap, then the solution lies within the solution space 102, but not within the subset 105. Note that the challenge might have been more specifically defined by the client group to include traps that release a gas that instantly paralyzes the mouse. If, however such a gas does not exist, e.g., is not a member of the element space, the challenge space would lie partially outside of the solution space 102.

The exemplary embodiments employ a clear definition of the Critical Challenge (CC), as follows:
(1) A clear and concise statement of the problem or need.
(2) A statement of how others have tried to solve the problem or meet the need in the past that clearly identifies the functionality of past solutions, their attributes and the elements and relationships used to achieve them.
(3) A statement of the shortcomings of past solutions.
(4) A definition of the ideal solution and the attributes that would characterize its functionality.

Thus, the Critical Challenge can include the optimal form of the problem, wherein, when presented with a problem statement in various stages of completeness/quality, the exemplary embodiments can perform the processing steps described herein for defining the Critical Challenge. Accordingly, the Critical Challenge can include (1) the concise statement of the problem, (2) the summary of past approaches, (3) the shortcomings of past approaches, (4) the set of attributes and characteristics of the ideal solution (e.g., referred to as the ideal attributes), and the like.

Those skilled in the art will realize that the above method of defining the challenge is unique in that it positions the problem or need to be solved in terms of the three spaces mentioned earlier, that is, challenge-space, solution-space and element-relationship-space. Thus, the challenge is formatted in a manner that is particularly appropriate to the exemplary embodiments and, in particular, to the search procedure used therewithin.

A subsequent step in the exemplary embodiments is to structure searches that provide documents that function as good extrinsic stimulants (e.g., motivators) to the client group, motivating them to solve the challenge. An exemplary extrinsic stimulant can be non-controlling, informational, enabling and provide an external competitor. By way of example, a class of documents that satisfy these criteria is patents, and the like.

In addition, to be effective extrinsic motivators the selected patents need to be relevant. To be relevant the patents can address the challenge at hand in one or more of the three spaces defined before. That is: 1) the patent can be addressing a similar or analogous problem or need or, a non-analogous problem that can be made contextually analogous, 2) provide functionality and attributes similar to those envisioned for the ideal solution, and 3) inform and educate inventors about elements and relationships that are potentially useful in achieving the desired functionality. Using the definition of the Critical Challenge as employed by the exemplary embodiments, it is possible to conduct a search of the patent/publication database that produces patents/publications that satisfy the three above criteria. It is noted that there are several computer-based search methods (e.g., search engines) that can be applied to extract information from the database of patents and publications so as to meet the objects of the exemplary embodiments. Boolean or logic based search algorithms and the engines that use them, as an example, can be employed and, if provided with the proper input, e.g., if their search addresses the challenge space, the solution space and the element/relationship space, any of these search engines can be effectively used. As will be noted further below, the exemplary embodiments can employ an exemplary search engine, “Akribis,” and the like. While the speed of the present exemplary embodiments in converging upon a satisfactory solution to the challenge may be enhanced by the efficacy of the noted search engine, the exemplary embodiments can be employed with various types of search engines. However, the extensive nature of the database search and the three perspectives through which it is implemented, makes the use of the computer highly advantageous.

The exemplary embodiments further can include a brainstorming session that is modified and improved so that the search results are used as extrinsic motivators to stimulate creativity. The search results also provide examples of elements and relationships that are drawn from the patented and published experiences of all the scientists, engineers and creative people that have contributed to the documented results of worldwide research and development.

Thus, advantageously, the exemplary embodiments provide a creativity enhancing, computer-assisted method and system for mining a database of patents and forming therefrom an appropriate knowledge-base, which is then used within an improved brainstorming process so as to enhance domain skills and task motivation of a client group and lead, thereby, to the solution of a challenging problem (the “critical challenge”).

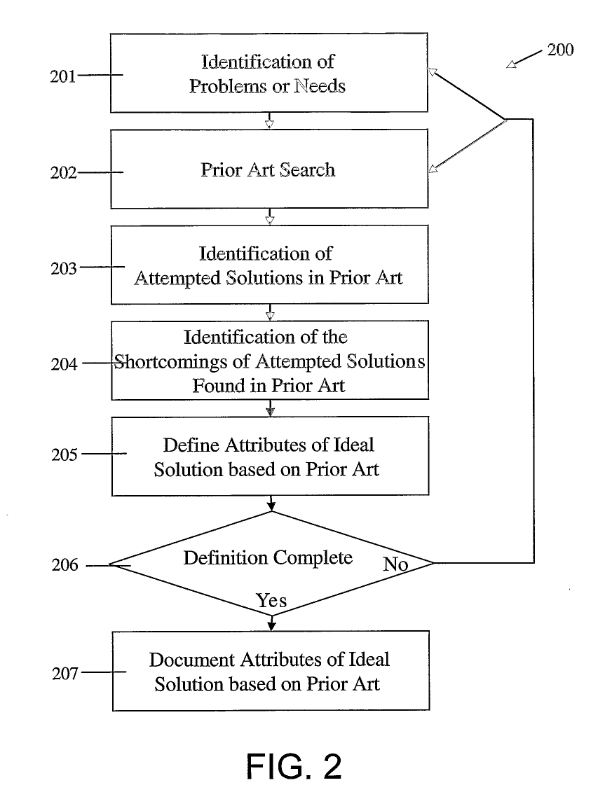

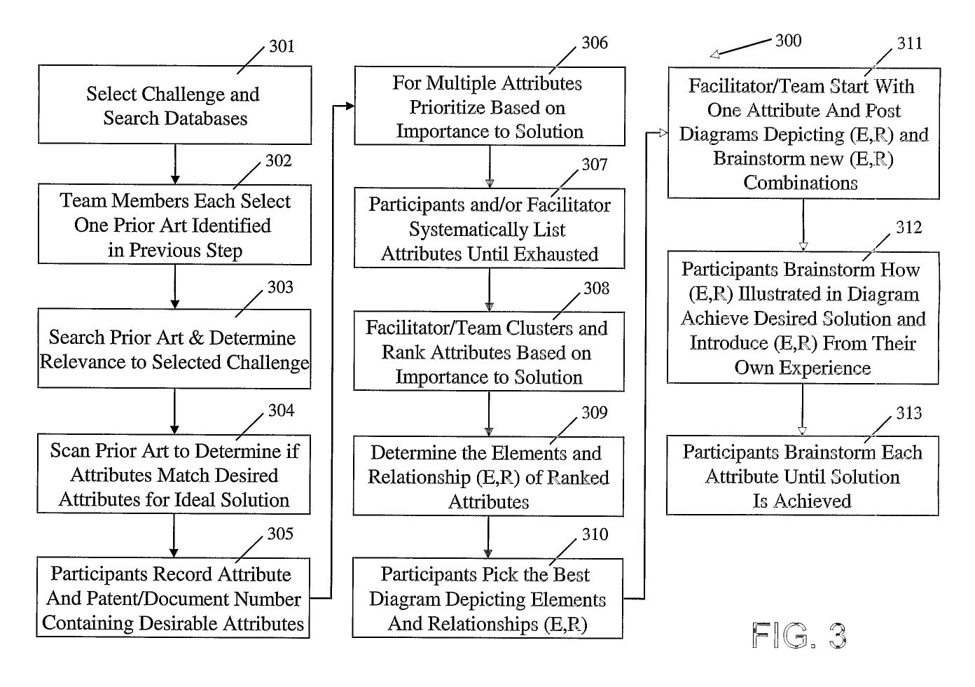

Referring now to FIG. 2, we briefly describe flowchart elements of the process 200 of exemplary embodiments to define well formatted critical challenges. The output of this process flow becomes an input to initiate the larger method of the exemplary embodiments as set forth in FIG. 3.

Step 201: Identify the problem or need to be solved. This step, which is equivalent to defining the challenge space 101 (or a subset thereof), can also appear in the brainstorming process 300 of the exemplary embodiments, more fully described below with reference to FIG. 3. It is understood that the identification of the challenge can also include a desired “ideal” solution to the problem (step 207). At step 201, the properties of the ideal solution may not yet be fully or adequately formed in the minds of the participants, but repeated iterations of the steps can more fully form these properties and the prospects for success of the process can improve as the ideal properties are refined.

Step 202: Perform a prior art search. This search can be carried out by members of the client group based on the knowledge possessed by its individual members. Alternatively, it can be carried out by a professional search service. It is understood that this search can be enhanced by any of several patent search engines publicly available (e.g., the USPTO, EP, PCT, and like, patent search engines, and the like).

Step 203: As a result of the search, identify prior art solutions that do, to some degree, solve the challenge problem or a similar problem, but may not possess all the necessary or desired attributes of the challenge solution being sought (e.g., the ideal solution).

Step 204: Describe the shortcomings within the identified prior art solutions so as to ascertain why these solutions do not, inherently and in and of themselves, completely solve the challenge problem.

Step 205: Sharpen the employed attributes of the sought after ideal solution based on an evaluation of the already discovered, but not satisfactory, prior art solutions. The sharpened qualifications of the ideal solution then serve as a re-identification of the challenge problem for step 207.

Step 206: If the group considers the definition of the Critical Challenge complete proceed to step 207, if not, then return to steps 201 or 202 and iterate until the definition is complete.

Step 207: Using the results of steps 201-205, document the critical challenge in the following format: (A) a clear statement of the challenge (step 201); (B) a description of the way in which others have attempted to solve the problem (step 203); (C) the shortcomings of those attempts (step 204), and (D) a precise explanation of the attributes necessary for the solution to be ideal (step 205).

Referring to FIG. 3, there is shown the thirteen-step flow chart of the brainstorming process 300 of the exemplary embodiments. The present invention includes recognition of existing brainstorming techniques and their shortcomings. For example, existing brainstorming techniques, that are limited by the number of participants and their depth and breadth of knowledge, tend to produce a large number of irrelevant results. Advantageously, the brainstorming technique of the exemplary embodiments produces more focused results leading to more rapid innovation of solutions while leveraging the documented creativity of the engineers and scientists that participate in the near one trillion dollars of R&D that is conducted by the OECD nations annually.

As noted above, the seven steps of the process 200 of FIG. 2, leading to the documentation of a critical challenge, can form an effective, though preliminary, result that serves as the input to the brainstorming process 300 of the exemplary embodiments described in FIG. 3. It should be noted that in some instances the critical challenge would already be fully defined through some other method and therefore not employ the process 200 depicted in FIG. 2. Alternatively, the client group will not have the authority to explore, enhance or change the definition of the critical challenge. In those cases, the fully defined critical challenge can become the input to the improved brainstorming process 300 depicted in FIG. 3 and described in more detail below.

Step 301: In the brainstorming process 300 of the exemplary embodiments, the participants begin with the critical challenge as documented in the form of the final step (step 207) of the flowchart of FIG. 2 described above. Note that the documented form need not necessarily have been produced by an application of the steps in the flowchart of FIG. 2, but documentation in that form is optimum to initiate the process 300 of the exemplary embodiments. The critical challenge is then presented to the computer-assisted search, which retrieves and lists a group of patents and/or publications (step 202), and the like. As noted above, in a wide range of applications of the exemplary embodiments, an exemplary search engine, “Akribis,” which is available from Innovation Business Partners, Inc., has successfully carried out searches through the challenge 101, solution 102, elements 103/relationships 104 spaces of the database in a manner that achieves the objects of the exemplary embodiments. While this search engine has performed consistently and well, its use is not considered to be a limiting factor in the successful application of the exemplary embodiments. For example, other search engines can be applied and other databases such as technical and scientific journals can be used. The exemplary embodiments do not include exhaustive investigation of the attributes of available search engines and do not discourage such an investigation by others. The present invention, however, recognizes that the more exhaustive the search methodology is, the more fully the three spaces are searched and the more selective are the search results, the more will task motivation be enhanced and the more efficiently will the exemplary embodiments operate.

Step 302: Each member of the team selects one or more patents/publications from the list formed by application of the computer-assisted search methodology chosen for the process. Optimally, each participant selects a different patent(s)/publication(s) from those selected by the other participants, however, optionally all participants can consider the same set of patents/publications.

Step 303: Each team member reads the patent(s)/publication(s) they have selected to determine their relevance to the critical challenge the brainstorming team is addressing. At this stage the reading may be relatively cursory and can include a reading of the abstract and a sufficient portion of the background to assess the relevance of the material. A more detailed analysis begins when papers or patents that address components of the ideal solution have been identified.

Step 304: Each team member reads the patent/publication they have selected as being relevant to determine if the attributes of the functionality or solution presented in the patent/publication are the same or similar to the functionality and attributes that were defined initially for the ideal solution to the brainstorming team's critical challenge. The present invention recognizes that the information included in the abstract or background of the description of invention is most useful for this step.

Step 305: For each desirable attribute discovered in a patent/publication, the participant records a description of the attribute achieved by the inventor/author and its patent number or journal identifier 305. These descriptions can most effectively be documented by storage in a computer for subsequent retrieval, including use of electronic notes, collaborative software, and the like, but slips of paper, Post-It™ notes or any other retrievable form that can allow them to be used in the next step of the process can be used.

Step 306: If more than one attribute is recorded for a given patent, then the participant creates separate entries for each attribute and prioritizes the collection of attributes according to their perceived importance to the desired ideal solution.

Step 307: In this process step, the facilitator of the brainstorming session begins with one participant and systematically proceeds around the group asking each participant for the attribute and patent number that they deem most important. It is here that the retrieval of a computer file and its display to the participants can be particularly efficient, but if the attributes and patent numbers or journal identification are written on Post-It™ notes then the facilitator can easily post the notes on some structure such as the wall, a flipchart or a blackboard. The facilitator continues to go around the group again and again till the collection of attributes and patent numbers has been exhausted.

Step 308: Net the facilitator alone, or with the group participating, clusters and ranks the attributes according to the importance of their attributes to the ideal solution. Each cluster then can include a collection of patents/publications that describe inventions that provide a means (elements 103, relationships 104, elements+relationships 105) for producing that desirable attribute. Each patent may represent a different means, mechanism or method of achieving that attribute but all will by some manner achieve it.

Step 309: Starting with the attribute the team considers most important in their ideal solution, the facilitator can list the patents/publications within that cluster that document one or more ways of achieving that attribute. The next step is for the participants to determine the elements 103 and relationships 104 that were used by the inventor(s) to achieve the desired attribute. If the team is using patents rather than publications, the present invention recognizes that the description or summary description of the invention and claims can be most useful in identifying elements 103 and relationships 104.

Step 310: If the documents being used include drawings, such as the figures of a patent, the optimal way of documenting the elements 103 and relationships 104 that achieve the attribute is to select the drawing that best illustrates the elements and relationships. If the document does not include figures, then the participant generates a simple diagram or schematic illustrating the elements 103 and relationships 104. Each diagram is annotated with the document identification such as the patent number or journal identifier.

Step 311: Starting with one attribute, the facilitator exhibits or otherwise posts the diagrams that illustrate how other inventors have achieved that attribute with a given set of elements 103 and relationships 104 on the wall, blackboard or flipchart or and electronic display or the like. The team members each then explain to the rest of the team how that set of elements 103 and relationships 104 from the patent they have chosen achieves the desired attribute. The team then begins to brainstorm how the elements 103 and relationships 104 illustrated in the diagrams, which may be from multiple inventions, might be combined to achieve the desired attribute for the ideal solution of their particular challenge.

Step 312: At this point in the process the team may also introduce elements 103 and relationships 104 that they were aware of from their own experiences, thus enhancing the pool of elements and relationships the team has to draw upon.

Step 313: As the brainstorming continues, the team can progress through all of the desirable attributes of the ideal solution. Brainstorming the set of elements 103 and relationships 104 that produce the N^{th} attribute may cause the team to reconsider the solution for a previous attribute and so the process continues iteratively until there is convergence upon a consistent set of elements 103 and relationships 104 that produce the optimal set of attributes for the ideal solution 207. The elements 103 and relationships 104 thus obtained are then transformed into an invention that meets a need or solves a long-standing problem (e.g., the critical challenge). Thus, the database, through multi-perspective mining, has become a knowledge base and the knowledge base, through the brainstorming process has been transformed into a sought-after composition of matter, physical object or process, and the like: the solution to the critical challenge.

Advantageously, the exemplary embodiments allow the brainstorming team to effectively use the results of the worldwide expenditures on research and development to provide a collection of elements 103 and relationships 104 that can be used to achieve an ideal solution of a challenging problem. In addition, the exemplary embodiments allows the brainstorming team to reach out well beyond the bounds of the immediate experiences of the brainstorming participants and tap broadly, yet selectively, into the documented knowledge of engineers, scientists and creative people worldwide.

The above-described devices and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanism can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Thus, a creativity enhancing, computer-assisted brainstorming system and method for solving challenging problems and producing inventions are provided, including generating a clear definition of the challenge from three perspectives: a challenge space; a solution space and an element/relationship space. A computerized search-engine for mining a database of patents/publications from such perspectives and for forming therefrom an appropriate knowledge-base is provided, and which is then used within an improved brainstorming process. The brainstorming process differs from those of the prior art in that use of the process enhances domain skills of a client group and provides the client group with task motivation.

Wile the present inventions have been described in connection with a number of exemplary embodiments, and implementations, the present inventions are not so limited, but rather cover various modifications, and equivalent arrangements, which fall within the purview of the appended claims.

What is claimed is:

1. A computer assisted, convergent iterative method for creating an optimal definition of a problem or need, the optimal definition comprising a critical challenge (CC), and producing a solution thereto, the method comprising:
providing an initial statement of the problem or need;
using a computer assisted search method, including,
(1) providing the initial statement of the problem or need and attributes of the solution thereto,
(2) performing a search within a first database that includes prior art documentation of past attempts at resolving the problem or need,
(3) forming, in accord with the results of the search, a second database including solutions within the first database directed at the problem or need as defined in the initial statement and constructing an initial list of desired solution characteristics of the problem or need,
(4) examining the solutions within the second database to determine whether or not a solution resides therein that has the desired solution characteristics and if so terminating the search, and if not:
(5) analyzing the solutions within the second database to determine why the solutions within the second database fail to satisfy the desired solution characteristics, and determining reasons why the solutions within the second database fail to satisfy the desired solution characteristics, and
(6) redefining the initial problem or need statement in a more optimal form using the determined reasons for failure to re-evaluate the desired solution characteristics and to produce another set of solution characteristics for the more optimal form;
using the search method, performing additional searches of the first database in accord with steps (1)-(6) until either (a) ideal solution characteristics of the CC have been satisfied and the CC is considered solved or (b) the definition of the CC is configured in a maximally optimal form; and
presenting the solution or the maximally optimal form.

2. The method of claim 1 further comprising:
using the search method to systematically search the first database from the perspectives of a challenge space, a solution space and an element-relationship space, the systematic search, including,
(a) seeking a first subset of the first database, the first subset comprising equivalent problems within a challenge space, the equivalent problems arising from related or previously non-related domains,
(b) seeking a second subset of the first database, the second subset comprising solutions to equivalent problems within a solution space, including either complete or partial solutions to the CC, and
(c) seeking a third subset of the first database, the third subset comprising solutions to equivalent problems within an element-relationship space, including solutions to equivalent problems having elements and functional interrelationships between elements that, when satisfied, form a CC solution or a part of the CC solution; and
combining the first, second and third subsets to form a resulting second database.

3. The method of claim 1, wherein the first database comprises a set of patents and publications, including patents and publications within the art of the CC and patents and publications within analogous and non-analogous arts.

4. The method of claim 1, wherein step (1) includes documenting the initial statement of the problem or need and the attributes of the solution thereto.

5. The method of claim 1, wherein step (5) includes documenting the reasons why the solutions within the second database fail to satisfy the desired solution characteristics.

6. The method of claim 1, further comprising (7) documenting the more optimal form.

7. The method of claim 1, further comprising implementing the method with one or more hardware and/or software devices configured to perform the method.

8. The method of claim 1, further comprising implementing the method with one or more computer readable instructions embedded on a computer readable medium and configured to cause one or more computer processors to perform the method.

9. A computer assisted method of finding innovative and creative solutions to a problem or need, the method comprising:
providing an initial problem or need statement expressed in an optimal form, the form having ideal solution attributes;
providing a database of selected problems from related or previously non-related domains and solutions to the problems and the elements and relationships between elements to achieve the solutions;
using a process of facilitated analysis, analyzing the attributes of the solutions to the selected problems to determine the applicability of the attributes to a solution of the initial problem or need;
ranking the attributes of the solutions to the selected problems in terms of the importance of the attributes to the desired solution to the initial problem or need;
using a process of facilitated analysis, analyzing the solution to each selected problem with desirable attributes to determine elements and relationships between elements used to achieve a method or means of solution of the selected problem;
determining applicability of the method or means of solution to achieving the remaining desirable solution attributes of the initial problem or need;
ranking the method or means of the analyzed solutions in order of applicability to the solution of the initial problem or need; and
applying or adapting the method or means to create a solution to the initial problem or need.

10. The method of claim 9, further comprising:
systematically searching the first database from the perspectives of a challenge space, a solution space and an element-relationship space, the systematic search, including,
(a) seeking a first subset of the first database, the first subset comprising equivalent problems within a challenge space, the equivalent problems arising from related or previously non-related domains,
(b) seeking a second subset of the first database, the second subset comprising solutions to equivalent problems within a solution space, including either complete or partial solutions to the initial problem or need, and
(c) seeking a third subset of the first database, the third subset comprising solutions to equivalent problems within an element-relationship space, including solutions to equivalent problems having elements and functional interrelationships between elements that, when satisfied, form a solution to the initial problem or need; and
combining the first, second and third subsets to form a resulting second database.

11. The method of claim 10, wherein the second database is enlarged to include elements and relationships not previously present but whose necessity is suggested by the results of the search.

12. The method of claim 9, wherein the process of facilitated analysis further comprises:
providing a pool of participants;
assigning to each participant a solution to an equivalent problem selected from the second database;
determining the particular solution attribute shared by the solution to the equivalent problem and the initial problem or need;
identifying the particular elements and relationships in the solution to the equivalent problem and the manner in which the particular elements and relationships are combined to form the equivalent problem solution;
determining the relevance and applicability of the combination to the initial problem or need; and
using experiences of the participants, improving the applicability of the problem solution by forming new combinations of elements and relationships.

13. The method of claim 9, wherein the identification of elements and relationships and the forming of new combinations thereof is enhanced by the physical act of posting separate lists of the elements and combinations and by the physical manipulation of the lists to aid mental conceptualization of the desired solution to the initial problem or need.

14. The method of claim 13, wherein the physical act of posting includes the affixing of notes at a commonly accessible site as well as the use of blackboards, flip charts or of a computer graphics display of stored comments within a shared computer system or network.

15. The method of claim 9, wherein the solution is expressed as an invention, a patent or a publication.

16. The method of claim 9, wherein the initial problem or need comprises a critical challenge (CC).

17. The method of claim 9, wherein the optimal form of the initial problem or need comprises a maximally optimal form of the initial problem or need.

18. The method of claim 9, wherein the optimal form of the initial problem or need comprises a less than maximally optimal form of the initial problem or need.

19. The method of claim 10, wherein the process of facilitated analysis further comprises:
providing a facilitator; and
assigning to each participant by the facilitator, the solution to the equivalent problem selected from the second database;

20. The method of claim 9, further comprising implementing the method with one or more hardware and/or software devices configured to perform the method.

21. The method of claim 9, further comprising implementing the method with one or more computer readable instructions embedded on a computer readable medium and configured to cause one or more computer processors to perform the method.
